(19) United States
(12) Patent Application Publication
(10) Pub. No.: US 2005/0226148 A1
(43) Pub. Date: Oct. 13, 2005

(54) Method and apparatus for enabling redundancy in a network element architecture

(75) Inventor: Hamid Assarpour, Arlington, MA (US)

Correspondence Address: JOHN C. GORECKI, ESQ., 180 HEMLOCK HILL ROAD, CARLISLE, MA, 01741, US

(73) Assignee: Nortel Networks Limited, St. Laurent (CA)

(21) Appl. No.: 11/025,815

(22) Filed: Dec. 29, 2004

Related U.S. Application Data
(60) Provisional application No. 60/561,379, filed on Apr. 12, 2004.
(60) Provisional application No. 60/569,717, filed on May 10, 2004.

(51) Int. Cl. H04L 12/26

(52) U.S. Cl. 370/229; 370/360

(57) ABSTRACT

A network element includes a plurality of Input/Output Cards (IOCs), a plurality of Datapath Service Cards (DSCs); and at least one crosspoint switch card (XPC) configured to be able to selectively interconnect each of the IOCs with each of the DSCs. Enabling full interconnectivity between all the IOCs and DSCs enables greater sparing options within the network element. Additionally, network element is configured to enable the XPCs to be spared, thus eliminating the XPCs as a potential single source of failure in the network element.

### CROSS REFERENCE TO RELATED APPLICATIONS

This application claims priority to Provisional U.S. Patent Application No. 60/561,379, filed Apr. 12, 2004, and also claims priority to Provisional U.S. Patent Application No. 60/569,717, filed May 10, 2004, the content of each of which is hereby incorporated herein by reference.

### BACKGROUND

1. Field

The present invention relates to communication networks and, more particularly, to a method and apparatus for enabling redundancy in a network element architecture.

2. Description of the Related Art

Data communication networks generally include numerous routers and switches coupled together and configured to pass data to one another. These devices will be referred to herein as “network elements.” Data is communicated through the data communication network by passing protocol data units, such as packets, frames, cells, or segments, between the network elements over one or more communication links formed using optical fibers, copper or other metallic wires, or wireless signals. A particular packet may be handled by multiple network elements and cross multiple communication links as it travels between its source and its destination over the network.

FIG. 1 illustrates an example communication network in which local area networks 10 are connected by a network element 12 to another network domain 14 having high speed communication links 16 interconnecting high speed network elements 18. The several network elements may be implemented in a similar fashion or differently depending on their intended use on the network. While FIG. 1 is a relatively simplistic rendering of a communication network, in reality the networks can get quite complicated. As shown in FIG. 2, multiple network elements are generally housed together in a communication center and may be mounted in a racking system 19 or, alternatively, may be free-standing.

As communications networks increase in size and sophistication, the demands put on the network elements have likewise increased to the point where a given network element may be configured to handle multiple terabits of data per second. To accommodate this increased amount of data traffic, the internal architecture used to implement network elements has changed over time. Generally, a network element has a control plane and a data plane. The control plane controls overall operation of the network element and the data plane is configured or optimized to handle data traffic on behalf of the network element. For example, a typical data plane includes circuitry configured to interface the communication links, such as to receive the physical signals from the communication links, extract data from the physical signals, perform noise reduction and other signal processing functions, and optionally group the received signals into packets or other logical associations of bits and bytes. This type of initial processing will be called I/O processing.

In addition, a typical data plane will process packets or frames of data to cause those packets/frames to be switched or forwarded onto one or more communication links. This additional processing will be referred to as datapath service processing, which may include extracting information from a header or label associated with the packet, or other functions that may be necessary or desirable to be performed in connection with the packet/frame or stream of packets/frames.

Previous generation network elements, and some existing network elements, used functional cards in which both I/O processing functions and datapath service functions were performed on the same network card. A network card, or “functional card” as that term is used herein, is generally formed from a printed circuit board on which processing circuitry is implemented. The functional cards are plugged into a connector plane in much the same way as a memory card is plugged into a motherboard of a computer. FIG. 3 illustrates a set of functional cards 20 plugged into a connector plane at the rear of a network element (referred to herein as a backplane 22) and FIG. 4 illustrates a set of functional cards plugged into a connector plane in the middle of the network element (referred to herein as mid-plane 24).

Using integrated functional cards began to exhibit drawbacks as network data rates increased and advances were made in the processing circuitry art. For example, a given functional card can only host a limited number of connections to physical communication links, such as fiber optic and wire connections, due to the finite amount of space available on the front edge of the card to carry the line connectors. As processing technology increased, datapath services processing circuitry on the board advanced so that it was able to handle more traffic than could be connected to the functional card over this limited number of connectors. Thus, using integrated functional cards required the datapath services aspect of the network element to be overbuilt.

To solve this problem, an architecture was developed in which different functional cards were used to implement I/O and datapath service functions. A functional card that is configured to perform Input and Output functions will be referred to herein as an IOC, and a functional card that is configured to perform datapath service functions will be referred to herein as a DSC. This architecture has been widely adopted and many large network elements now include a plurality of IOCs, a plurality of DSCs, and optionally one or more other functional cards such as server cards, all interconnected by a midplane or backplane. Mid-planes and back-planes will collectively be referred to herein as “connector planes.” In a mid-plane architecture, the IOCs are generally inserted into connectors on the front of the mid-plane from the front of the network element, and DSCs and other processing cards are inserted into connectors on the back of the mid-plane from the rear of the network element. In addition, as shown in FIG. 5, the functional cards may be full height cards such as cards 26 or fractional height cards such as cards 28.

In addition to increasing the network element's ability to handle increased amounts of data, it was also desirable to increase the reliability of the network element. One way to do this is to provide redundant functional cards such that if one of the IOCs or DSCs fails, another IOC or DSC can be automatically used in its place until the failing IOC or DSC is able to be replaced. The extra IOC or DSC will be referred to herein as a “spare” functional card. A functional card that has a dedicated spare will be referred to as being spared in a “1:1” fashion while a group of functional cards that are spared by a single functional card will be referred to as spared in a “1:n” fashion.

In conventional network elements, the paths through the midplane or backplane were fixed such that particular IOCs were required to connect to a particular DSC and vise versa. This result was dictated by the design of the traces on the connector plane. The result of this architecture was that the number and type of sparing that could be performed, and the manner in which interconnection of the functional cards could be implemented, was limited by the midplane or backplane design.

One way to avoid limitations of this nature is to provide full mesh interconnectivity between all functional cards in the network element via the connector plane. However, such a solution does not scale well. Specifically, if the connector plane is required to have a trace connecting every functional card to every other functional card, the number of traces on the midplane will be on the order of n², where n is the number of functional cards. Thus, while this solution may work where there is a limited number of functional cards, it becomes very difficult and ultimately cost prohibitive to create a midplane or backplane that is able to provide full mesh interconnectivity between IOCs and DSCs as the number of functional cards in use on the network element increases.

One attempt to provide greater interconnectivity without implementing a fully meshed midplane architecture is described in U.S. Provisional Patent Application No. 60/402,761, to Bradbury, et al., entitled “Redundancy Crossbar Card”, in which two crosspoint switches are used to interconnect groups of line cards and accelerator cards. In the Bradbury architecture, the line cards are separated into two groups with half of the line cards connected to one crosspoint switch and the other half connected to the other crosspoint switch. The accelerator cards are connected to both crosspoint switches.

While the Bradbury architecture allows sparing of accelerator cards in a 1:1 or 1:n manner, it does not allow the line cards to be spared in a similar manner. Specifically, since each line card is connected to only one crosspoint switch, failure of that crosspoint switch will cause a failure of all associated line cards. To prevent a failure of this nature from affecting traffic passing through the network element, the protection cards in Bradbury's architecture are required to be spared via a line card attached to the other crosspoint switch. Specifically, to avoid the crosspoint switches from becoming a single point of failure in the network element, line cards from one group of line cards are required to be spared by line cards in the other group. This places a restriction on the manner in which sparing may be implemented and also limits the number of cards that may be active on the network element since half of the line cards must be reserved as spare line cards. Accordingly, it would be desirable to provide a network element architecture that is able to enable greater interconnection between the functional cards of a network element.

### SUMMARY OF THE DISCLOSURE

The present invention overcomes these and other drawbacks by providing a method and apparatus for enabling full redundancy at the functional card level in a network element architecture. According to an embodiment of the invention, a network element, includes a plurality of Input/Output Cards (IOCs), a plurality of Datapath Service Cards (DSCs); and at least one crosspoint switch card (XPC) configured to be able to selectively interconnect each of the IOCs with each of the DSCs. Enabling full interconnectivity between all the IOCs and DSCs enables greater sparing options within the network element. Additionally, according to another embodiment of the invention, at least one additional XPC may be provided, and network element is configured to enable the XPCs to be spared as well as the IOCs and DSCs.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of an example of a communication network including network elements;

FIG. 2 is a front view of a plurality of network elements housed together in a rack;

FIG. 3 is a perspective view of functional cards connected to a backplane;

FIG. 4 is a perspective view of functional cards connected to a mid-plane;

FIG. 5 is a perspective view of functional cards of different heights connected to a mid-plane;

FIG. 6 is a functional block diagram of an example selection of functional cards connected to a mid-plane according to an embodiment of the invention;

FIG. 7 is a functional block diagram illustrating signal paths on a mid-plane that may be used to interconnect functional cards with one or more crosspoint switches according to an embodiment of the invention;

FIG. 8 is a functional block diagram of a channel between an IOC and a DSC according to an embodiment of the invention;

FIG. 9 is a functional block diagram of a crosspoint switch according to an embodiment of the invention;

FIG. 10 is a functional block diagram illustrating interconnection of IOCs, XPCs, and DSCs in a network element, according to an embodiment of the invention;

FIG. 11 is a functional block diagram illustrating interconnection of Input/Output Cards (IOCs) with Datapath Service Cards (DSCs) via redundant crosspoint switches;

FIG. 12 is a functional block diagram of a network element configured to implement full redundancy in the data plane according to an embodiment of the invention;

FIG. 13 is a functional block diagram illustrating example interconnections that may be made using the redundant crosspoint switch architecture according to an embodiment of the invention;

FIGS. 14a-14c are functional block diagrams illustrating 1:1, 1:n, and m:n sparing of IOCs in a dataplane of a network element according to an embodiment of the invention;

FIG. 15, is a functional block diagram illustrating sparing of cross point switch cards and IOCs in a dataplane of a network element according to an embodiment of the invention;

FIG. 16 is a functional block diagram illustrating interconnection of functional cards to enable sparing of IOCs, DSCs, and XPCs, in a data plane of a network element according to an embodiment of the invention; and

FIG. 17 is a functional block diagram illustrating possible sparing combinations between IOCs and DSCs in a network element according to an embodiment of the invention.

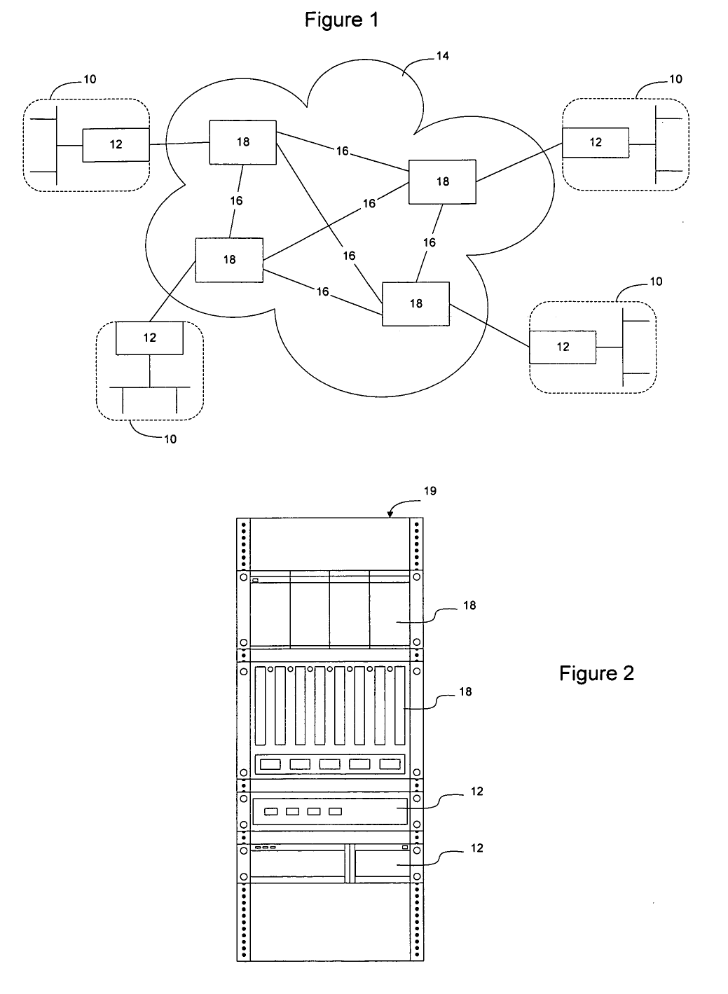

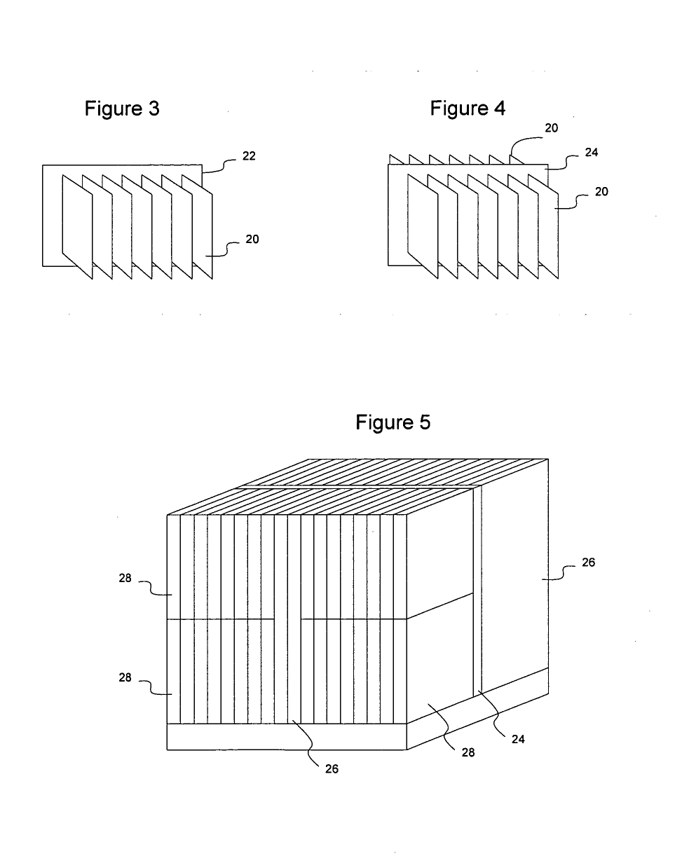

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

As described in greater detail below, the method and apparatus of the present invention enables full redundancy at the functional card level in a network element architecture. According to an embodiment of the invention, a network element, includes a plurality of Input/Output Cards (IOCs), a plurality of Datapath Service Cards (DSCs); and at least one crosspoint switch card (XPC) configured to be able to selectively interconnect each of the IOCs with each of the DSCs. Enabling full interconnectivity between all the IOCs and DSCs enables greater sparing options within the network element. Additionally, the network element may be provided with more than one XPC and configured to enable the XPCs to be spared as well.

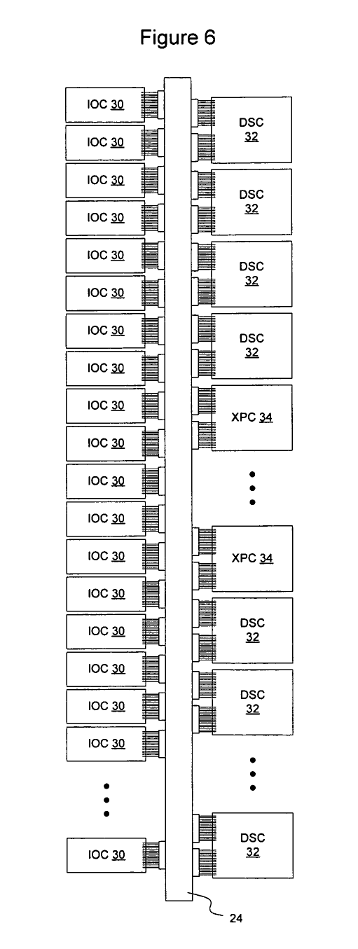

FIG. 6 illustrates a number of functional cards connected to a mid-plane according to an embodiment of the invention. As shown in FIG. 6, Input/Output Cards (IOCs) 30 and Datapath Service Cards (DSCs) 32 are interconnected using a connector plane and one or more crosspoint switches (XPCs) 34 such that any IOC may be connected to any other IOC, any IOC may be connected to any DSC, and any DSC may be connected to any other DSC via any XPC in the network element. Additionally, implementation of an architecture of this nature, as discussed in greater detail below, enables 1:1, 1:n, and m:n sparing of IOCs, server cards, and DSCs in the network element. M:n sparing will be used herein to refer to a situation where two or more functional cards may be used as spares for a group of other functional cards. Additionally, as illustrated in FIG. 6, providing redundant XPCs with full interconnection of the IOCs and DSCs to each of the XPCs enables 1:1 or 1:n sparing of the XPCs to enable redundancy to be provided to the crosspoint switches as well as the other functional cards in the network element.

In the embodiment illustrated in FIG. 6, a mid-plane has been used to connect the functional cards together. The invention is not limited in this manner as a back-plane could be used as well. The invention is also not limited to an embodiment using the illustrated number of functional cards as numerous types and quantities of functional cards may be used in a network element.

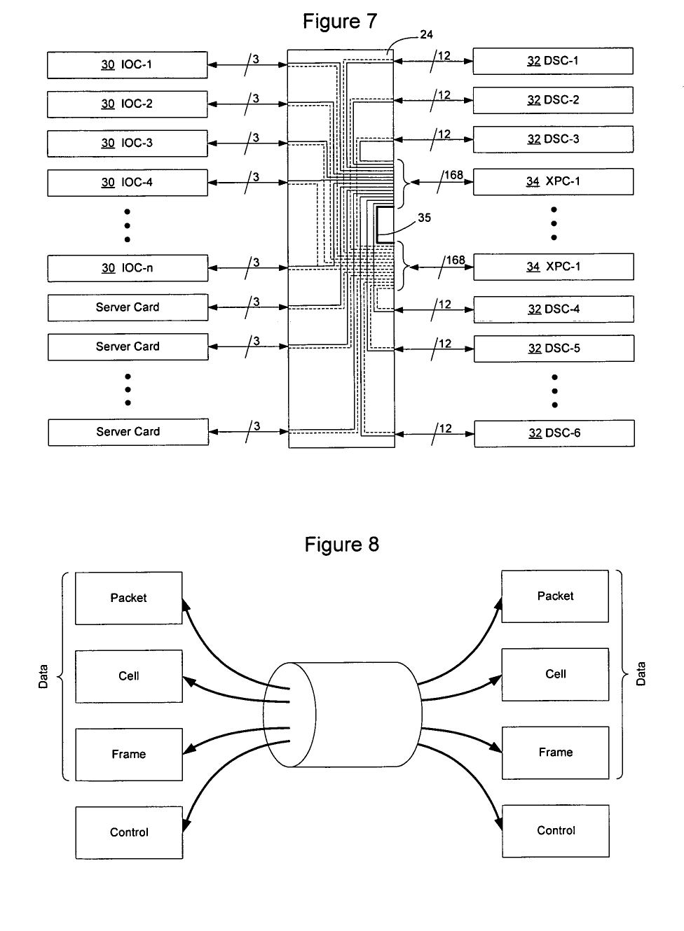

FIG. 7 illustrates interconnections within an example mid-plane to enable redundant XPCs to be used in connection with redundant IOCs and DSCs. As shown in FIG. 7, each IOC is connected to a first XPC via a first trace (solid line) and is connected to a second XPC via a second trace (dashed line). The XPCs are interconnected via a plurality of traces represented by the heavier weighted solid line 35 which may be used facilitate interconnection of IOCs and DSCs as discussed in greater detail below. The XPCs are configured to switch signals from the IOC card to another IOC or to a DSC via a trace extending from that XPC to the other functional card. For example, assume that signals received at IOC 1 were to be transferred to DSC 3. Signals from IOC 1 are thus transmitted from IOC 1 to one of the XPCs via traces in the connector plane, switched by the XPC, and output via the traces on the connector plane to the appropriate DSC.

By using an XPC to transfer signals between traces on the connector plane, full interconnection of all functional cards may be achieved without requiring the midplane to have n2 traces between each of the functional cards. Rather, full mesh interconnectivity may be achieved using only the order of n traces on the connector plane, and causing the signals to traverse the midplane two times—once from the IOC to the XPC, and once from the XPC to the DSC.

As shown in FIG. 7, the functional cards such as the IOCs and DSCs may have multiple connections to the mid-plane. For example, in the illustrated embodiment the IOCs each have three pairs of unidirectional links (one of each pair of links carrying data from the IOC to the midplane and the other of each pair of links carrying data from the midplane to the IOC), with each link capable of carrying data at up to 3.125 or other convenient line rate. The invention is not limited to the particular link speeds used to implement an embodiment of the invention. Similarly, each of the DSCs is connected to the connector plane using 12 pairs of unidirectional links operating at similar bandwidths. Connecting the DSCs to the midplane using 12 pairs of links allows a greater number of IOCs to connect to each of the DSCs to thereby reduce the number of DSCs required in the network element.

In the embodiment illustrated in FIG. 7, the IOCs may connect to more than one DSC by causing the XPC to direct signals on the three links to different functional cards. Thus, one set of signals being transferred on a first of the three links connecting the IOC to the connector plane may be handled by a first DSC, a second set of signals on the second of the three links may be handled by a second DSC, and a third set of signals on the third of the three links may be handled by a third DSC. This allows for greater flexibility in the type of communications that may be handled by a given IOC and, hence, by the network element. For example, Packet Over SONET (POS) traffic may be sent to one DSC, ATM traffic may be sent to another DSC, and a third type of traffic may be sent to another DSC. While an embodiment in which three pairs of links are used to connect the IOC to the connector plane has been described herein, the invention is not limited in this manner as any number of links may be used to connect the IOCs to the connector plane. Similarly, the invention is not limited to a DSC that uses twelve pairs of links to connect to the connector plane as other numbers of links may be used to connect these components of the network element.

In the illustrated embodiment, since each IOC has 3 links to the connector plane and each DSC has 12 links to the connector plane, each DSC can handle the traffic from between one and twelve IOCs. To increase this number, the number of links from the DSC to the connector plane may be increased or traffic from multiple IOCs may be aggregated at another IOC before being transmitted to the DSC. For example, traffic from several IOCs may be sent to another IOC, aggregated, and then forwarded from that IOC to the DSC using a single link. Using a single level of compression of this nature allows 36 IOCs to connect to one DSC, provided that the IOCs and DSCs are connected as discussed above, and further provided that there are 36 IOCs in the network element to be connected to the designated DSC.

One advantage of allowing multiple IOCs to be connected to any given DSC is that Automatic Protection Switching (APS) in a SONET network may be performed at the DSC rather than at the IOC which reduces the need to have the IOCs handling the traffic for a particular SONET ring to be connected together.

To understand this advantage, it may be useful to look at FIG. 7 and assume, for the sake of this example, that a SONET ring is provisioned through IOCs 1 and 2. In a SONET network, a SONET ring has protection and working fibers extending around the ring and network elements on the ring always transmit traffic onto both working an protection paths to accelerate protection switching between the paths. On the receive side, the SONET traffic is pulled off of the working fiber or protection fiber depending on the state of the ring. One aspect of this selection is referred to as Automatic Protection Switching (APS).

Conventionally, to allow IOC sparing in a SONET switch, the IOCs would be physically linked together and APS selection of one of the incoming SONET streams of traffic would be performed by the IOCs. According to an embodiment of the invention, by allowing each of the IOCs to be connected to any arbitrary DSC, APS switching may instead be performed by the DSCs rather than the IOCs, to allow a given DSC to select one of the incoming SONET streams, so that the fibers forming the SONET ring may be homed to different IOCs without requiring the IOCs to be separately interconnected.

The network element of FIG. 7 may also include one or more IOC server cards configured to provide services on the network element. For example, the server cards may process traffic to be output over the network, such as to encrypt the traffic, replicate the traffic, or otherwise alter the content of the data. For example, the server cards may execute security, VPN, and other services for the network element. Other services may be performed as well and the invention is not limited to an embodiment that implements these particular selection of services.

FIG. 8 illustrates a channel extending between an IOC and a DSC in a network element according to an embodiment of the invention. As shown in FIG. 8, the channel includes data traffic including packets, cells, frames, or other protocol data units, and control traffic configured to enable control messages to be passed between the IOC and DSC cards. According to an embodiment of the invention, traffic (such as SONET, Ethernet, and/or TDM traffic) is terminated at the IOC and formed into packets or frames at a framer on the IOC. The packets or frames are then passed over the channel to the DSC for processing and/or switching. Passing data between the IOC and DSC in packet format allows the network element to handle traffic on a per-packet basis, rather than on another aggregate basis such as a STS-1 basis, to achieve finer granularity of control over traffic passing through the network. The invention is not limited to an embodiment that performs functions on a per-packet basis, however, as other manners of handling data traffic may be used as well.

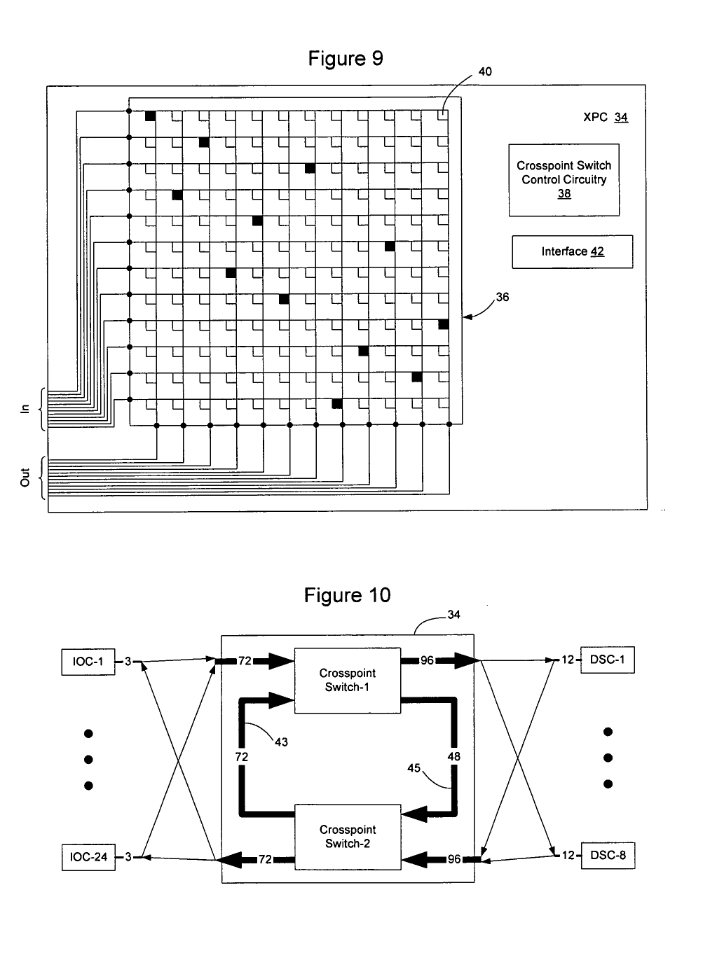

Each XPC 34 contains a statistically configured fully meshed cross point switch which provides for point to point interconnections between input and output ports. Since the input and output ports are connected to traces on the connector plane, the crosspoint switch allows any two traces on the connector plane to be connected to thereby enable any two functional cards to be interconnected. One example of an XPC is shown in FIG. 9, although the invention is not limited to this type of XPC as many types of XPCs and similarly configured switching architectures may be developed. Providing point-to-point connections between inputs and outputs provides faster interconnection than another architecture, such as a bus, in which only one input may be transmitting at a given time over the transmission mechanism. Likewise, the statically configured point-to-point crosspoint switch 36 is much less expensive than a dynamic switch structure. Thus, an XPC may be used, in one embodiment, to provide initial interconnectivity between IOCs and DSCs. As discussed below, the network element may use a switching fabric at a later stage of handling the packets, which may include a non-blocking dynamic switch structure, to switch signals between ports on IOCs. Use of a switch of this nature at a later stage to switch the signals is thus not precluded by use of a crosspoint switch to interconnect IOCs and DSCs for initial packet processing in the front end of the network element.

As shown in FIG. 9, the XPC card includes one or more crosspoint switches 36 as well as control circuitry 38 configured to enable the crosspoint switches to be controlled to selectively interconnect input and output ports. Control of the operation of the XPC generally causes interconnections to be made by latch mechanisms 40 at junctions between input lines and output lines. In the illustrated embodiment, activated latch mechanisms are illustrated as filled squares and inactive latch mechanisms are illustrated as empty squares.

The XPC may be accessed by a control program via interface 42. Although the XPC is described as being static, the connection of inputs and output ports can change over time as components fail, to allow sparing to occur on the network element and to allow configuration changes to be implemented on the network element. Thus, the term static implies a connection that does not change every time a new data packet is to be handled by the crosspoint switch.

The crosspoint switch, in addition to being fully meshed, is non-blocking such that signals arriving at an input are not blocked from arriving at their output destination. Several commercially available crosspoint switches that may be used to implement an embodiment of the invention are made by MindSpeed™, particularly the MindSpeed™ M21151 crosspoint switch and MindSpeed™ M21156 switches, although other crosspoint switches such as the M21131 and M21136 crosspoint switches made by MindSpeed™ or another manufacturer may be used as well. Both of these identified switches are 144×144 3.2 Gbps cross point switches, one which includes clock data recovery using an integrated phase locked loop and the other of which does not. The invention is not limited to an architecture using a switch of this size or a switch having these particular features, as many different cross point switches may be used to implement embodiments of the invention.

FIG. 10 illustrates an embodiment of the invention in which one XPC having two crosspoint switches is provided to enable interconnectivity between IOCs and between DSCs to be established. In the example shown in FIG. 10, particular numbers of IOCs, XPCs, and DSCs are illustrated and described. The invention is not limited to this particular example as many different numbers of these functional cards may be used without departing from the scope of the invention. Specifically, in the Example illustrated in FIG. 10, the network element includes 24 IOCs, one XPC having two crosspoint switches, and 8 DSCs. Each of the IOCs is connected to the XPC using three bi-directional links or a total of six connections. Each of the DSCs is connected to the XPC using 12 bi-directional inks or a total of 24 connections. The crosspoint switches on the XPC are connected to each other to allow IOCs to be connected to other IOCs without going through a DSC and to allow DSCs to be connected to DSCs without passing through an IOC. More particularly, in this example, crosspoint switch-1 is configured to use 72 input connections to service 3 links from each of the 24 IOCs, and to use 96 output connections to service 12 links to each of the 8 DSCs. Crosspoint switch-2 is similarly configured to use 96 input connections to service 12 links from each of the 8 DSCs, and to use 72 connections to service 3 links to each of the 24 IOCs. The remaining links (72 input links from crosspoint switch-2 to crosspoint switch-1 and 48 links from crosspoint switch-1 to crosspoint switch-2) are used to respectively provide DSC-DSC connectivity and to provide IOC to IOC connectivity. In this illustrated embodiment, a total of 168 input and output lines were required to provide full interconnectivity between the IOCs and DSCs. Since the available crosspoint switch had only 144 input and output lines, two crosspoint switches were used to provide full interconnectivity on the one crosspoint card. As larger crosspoint switches are developed or if fewer input and output lines were required, a single crosspoint switch may be used to implement connectivity in the XPC.

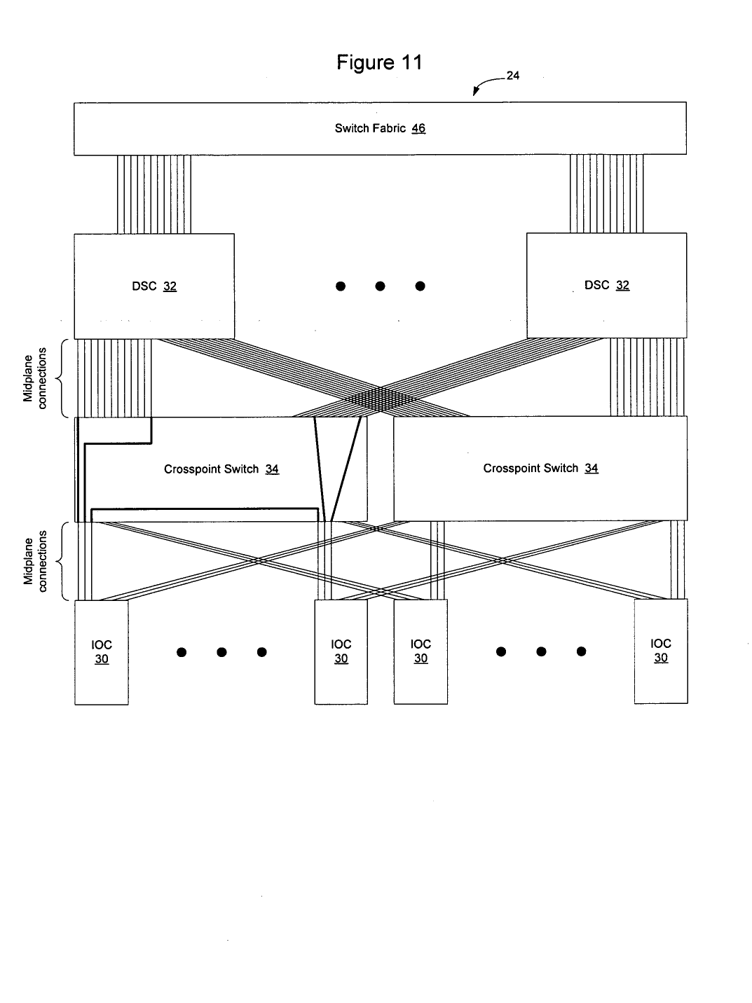

FIG. 11 illustrates a data plane 44 of an example network element. As shown in FIG. 11, IOCs 30 are connected via the connector plane to one or more of the crosspoint switches 34, which switch the signals from the IOC 30 to one or more of the DSCs 32. The crosspoint switches 34 may all be active and handling traffic on the network element or, alternatively, one of the crosspoint switches may be reserved and activated only upon failure of one of the working crosspoint switches. In the illustrated embodiment there are two crosspoint switches. The invention is not limited in this manner as more than two crosspoint switches may be used as well. According to an embodiment of the invention, every IOC is connected to at least one of the XPCs and all of the DSCs are likewise connected to that XPC to enable full interconnection between the IOCs and DSCs on the network element.

In the illustrated embodiment, the IOCs are connected to each crosspoint switch using three pairs of links. Since one of the XPCs is active for the particular IOC, the links to the other XPC will remain inactive until required. In the illustrated embodiment two of the links are connected to a first DSC and a third of the links from the first IOC is connected to a second IOC. Similarly, links from the second IOC are connected to a second DSC. Any implementation may be possible and the invention is not limited to this particular illustrated example. For simplicity not all of the connections implemented by the XPC have been illustrated in FIG. 11.

Signals received by the DSC are processed and passed to the switch fabric 46 to be switched between interfaces on the network element. The switch fabric 46 may be a dynamic non-blocking switch fabric architecture. Switch fabrics are well known in the industry and any conventional switch fabric may be used to switch packets between the different interfaces on the network elements. On the reverse path from the switch fabric to the IOCs, the packets will take the reverse path first traversing a DSC, then passing through one of the crosspoint switches, and then ultimately being formatted for transmission by one or more of the IOCs.

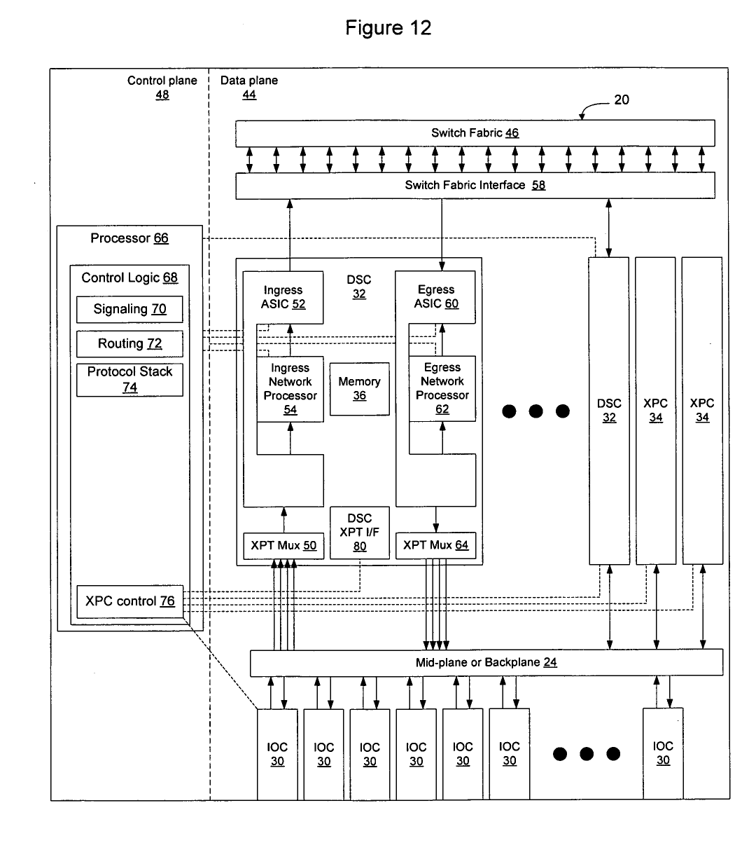

An example of a network element configured to use a data plane of this nature is illustrated in FIG. 12. As shown in FIG. 12, the network element includes a data plane 44 configured to handle data traffic on the network and a control plane 48 configured to enable higher level control of the network element to take place. In the illustrated embodiment, data traffic is received at the IOCs 30 and transferred through links in the midplane 24 to one or more of the XPCs 34 which control the interconnection between IOCs 30 and DSCs 32. The DSCs 32 receive the data traffic and perform packet processing on the received data traffic.

In the example data plane 44 illustrated in FIG. 12, traffic is received at a crosspoint multiplexer 50 which operates to select one or more active links from the available links is passed to an ingress ASIC 52. The ingress ASIC is supported by an ingress network processor 54 that performs data path servicing operations on the data. Optionally, a memory 56 may be provided to store data and instructions for execution by the ingress network processor 54. The data is then prepared to be forwarded to a switch fabric interface 58.

Packets or other logical associations of data are then passed to the switch fabric interface 58, switched in the switch fabric 46, and undergo additional processing on the reverse path through the DSC. For example, in the illustrated embodiment an egress ASIC 60 receives the packets, and strips off whatever overhead was added to enable the data to traverse through the switch fabric. Optionally, additional post switching processing may be performed on the data via egress ASIC 60 and associated egress network processor 62. The processed data is then passed to egress crosspoint multiplexer 64 which controls selection of links to cause the data to be passed to the appropriate IOC via one or more of the XPCs. After post switching processing in the DSC, the packets are passed via the midplane to the crosspoint switch where they are directed to the appropriate output IOC.

The control plane of the network element is configured to control operation of the network element and provides an interface to the external world to allow the network element to be controlled by a network manager. In the illustrated embodiment, the control plane includes a processor 66 executing control logic 68 that enables control operations to be executed on the network element. For example, the control logic 68 may include software subroutines and other programs to enable the network element to engage in signaling 70, routing 72, and other protocol exchanges 74 on the communication network. The invention is not limited to any particular implementation of the control plane 48 as numerous control planes may be used in connection with the dataplane architectures described herein.

According to an embodiment of the invention, the control logic is configured to implement a crosspoint control process 76 to enable the crosspoint switch to be programmed to interconnect particular IOCs with other IOCs, to interconnect IOCs with particular DSCs, interconnect DSCs, and to otherwise control interconnection of functional cards on the dataplane of the network element. As shown in FIG. 12, the XPC control may communicate with the DSCs, the XPCs, and the IOCs to allow these components to be instructed as to which links are to be used to communicate data and which traces on the connector plane are to be interconnected. For example, as mentioned above in connection with APS switching, multiple IOCs may be transmitting data streams to a particular DSC. The crosspoint control process 76 may be used to instruct the DSC as to which of the 12 available links are currently active, which of the currently active links are being used to carry traffic, and which links are logically bundled together. Similar configuration information may be provided via the crosspoint control process to the XPC and IOC cards as well. These and other control functions may be implemented via the crosspoint control process and the invention is not limited to the particular listed control functions.

Control instructions may be passed between the control process on the control plane of the network element and the functional cards that will implement the control instructions using out of band signaling over dedicated control lines as illustrated in FIG. 12. These control lines allow the control plane to set up connections between IOCs and DSCs and notify the components of failures and other events that may change the manner in which communications take place between the functional cards.

Alternatively, the control program may communicate with a subset of the functional cards and enable the functional cards to communicate with each other using in-band signaling to effect control of the system in a distributed fashion. For example, the control subsystem may communicate with the DSCs and cause the DSCs to control operation of the IOCs using a proprietary or open source protocol. In this example, according to one embodiment of the invention, the management of IOCs is handled by the control processor resident on the DSCs. The IOCs connected to the DSC are then managed by its control processor. A proprietary protocol supports transport of packets (ingress and egress directions) as well as control messages. These control messages may be transported in-band along with data as described above and as illustrated in connection with FIG. 8.

One protocol that may be used to effect control of the IOCs by the DSCs, according to an embodiment of the invention, includes three types of control messages: command messages, reply messages, and event messages. Command messages are sent from the control processor on a DSC to its designated IOC. Reply messages are sent form an IOC to the control processor on its designated DSC. These messages are generated in response to the command messages. Event messages are sent from an IOC to the control processor on its designated DSC and are generally generated due to the occurrence of a local event on the IOC, such as an interrupt or a timeout. Although a proprietary protocol has been described, other protocols may be able to be used to communicate between the IOCs and DSCs via the XPT.

The protocol may be used in a number of ways to enable the IOCs and DSCs to work together. For example, a DSC may instruct an IOC to cease transmitting data on a particular link and start transmitting data on another link. The IOC may output a response to the DSC upon completion of the instruction. These protocol exchanges of host messages are implemented on the data channel between the IOC and DSC to prevent duplicative control and data paths from being required between these components.

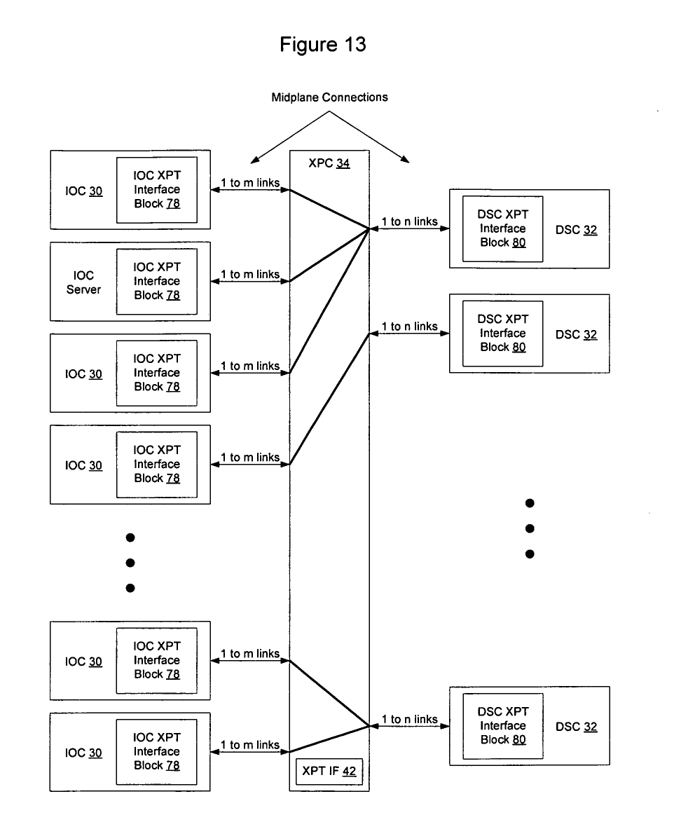

FIG. 13 illustrates a block diagram of an embodiment of the invention in which IOCs are connected to DSCs via midplane connections under the control of the XPT. It should be noted, in connection with this figure, that the midplane connections are actual physical serial connections formed on a midplane in the network element. Thus, the signals from the IOC pass through a first set of serial connections on the midplane to the XPC, are switched at the XPC to other serial connections on the midplane, and pass through those second serial connections on the same midplane to the intended DSC. The midplane connections were discussed in greater detail above.

As shown in FIG. 13, the IOC includes an IOC crosspoint (XPT) interface block. The IOC XPT interface is responsible for transport of various I/O bus protocols over 1 to m high-speed serial links. The IOC crosspoint interface block receives command messages, interfaces with processing circuitry on the IOC to implement the command, and issues reply messages to the DSC. The IOC XPT block 78 also generates the event messages upon occurrence of an event on the IOC. IOC control messages received at the IOC XPT block 78 are extracted and consumed locally on the IOC.

The DSC includes a DSC XPT interface block 80 which is responsible for the transport of packets and control messages over 1 to n high-speed serial links. It generates messages for transportation to the IOCs and receives reply and event messages from the IOCs.

The XPC is controlled by software, such as XPT control software, to provide proper interconnection between the IOCs and DSCs. As discussed above, the XPC includes an XPT I/F 42 to allow it to receive configuration input from the control plane 48.

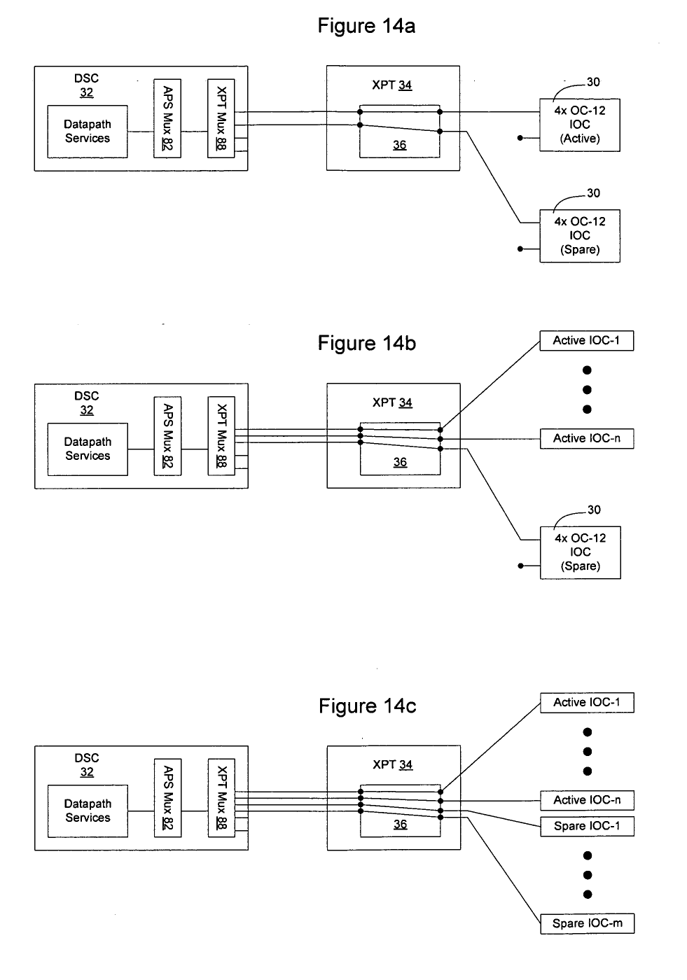

FIGS. 14-16 illustrate several protection schemes that may be implemented using the front end described herein. As shown in FIG. 14, 1:1 and 1:n sparing of IOCs is possible using the crosspoint switch 34 to direct traffic between a given DSC 32 and alternative IOCs 30. As discussed above, this may allow APS switching to occur at the DSC, for example via an APS MUX 80 rather than at the IOC 30, to allow for IOC sparing in a SONET system. Where the DSC is not required to operate in a SONET environment, this function may be disabled. In FIG. 14 each of the IOCs 30 is illustrated as being configured to implement four OC-12 interfaces. The invention is not limited in this manner as the IOCs may implement any desired number of interfaces at any desired line rate.

The IOCs are connected to the XPC via mid-plane links 84 and switched by the XPC to other mid-plane links 86 to arrive at a desired DSC 32. The DSC has an XPC multiplexer configured to selectively cause traffic to be active on one of the spared IOCs. In the illustrated example the top IOC in FIG. 14a has been designated as the active IOC and the bottom IOC has been designated as a spare IOC. FIGS. 14b and 14c illustrate similar systems except that FIG. 14b illustrates 1:n sparing and FIG. 14c illustrates m:n sparing.

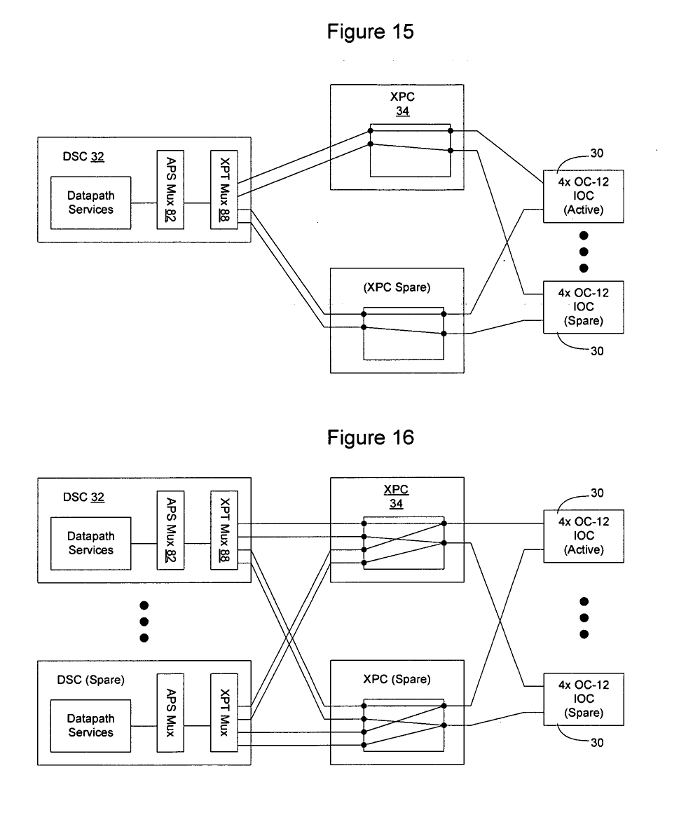

FIG. 15 illustrates an embodiment of the invention in which XPCs are spared as well as IOCs are spared. Sparing of the XPCs allows an XPC to be replaced upon occurrence of a failure in the XPC to thereby increase the reliability of the network element. Since each XPC is non-blocking and provides full mesh connectivity between all inputs and all outputs, each XPC is capable of handling communication between the IOCs and DSCs. Thus, according to one embodiment, one or a given subset of the XPCs may handle all of the connectivity between IOCs and DSCs while allowing the spare XPC to remain idle. In an alternative embodiment, the spare XPC may be configured to handle traffic while none of the XPCs is experiencing failure, and the load may be redistributed to the non-failing XPC(s) upon failure of one of the XPCs.

FIG. 16 illustrates an embodiment of the invention in which DSCs, XPCs, and IOCs are all spared. This allows DSCs to be replaced as failures occur on the DSCs. As shown in FIG. 16, the DSC XPT Mud allows particular XPCs to be selected to be used in transmitting signals between the IOCs and DSCs. Selection of DSC may occur by programming the XPT to transfer signals from a given IOC to multiple DSCs and controlling the DSCs to cause one to operate as the default DSC and the other to operate as a spare DSC such that that DSC will handle signals only upon failure of the default DSC. Alternatively, the XPT may be configured to transfer signals from selected IOCs to a given DSC and to transfer the signals from the selected IOCs to another given DSC or a group of other DSCs upon notification of a failure of the primary DSC. Other methods of sparing DSCs may be possible as well and the invention is not limited by the actual manner in which a change in control between spared DSCs is effected.

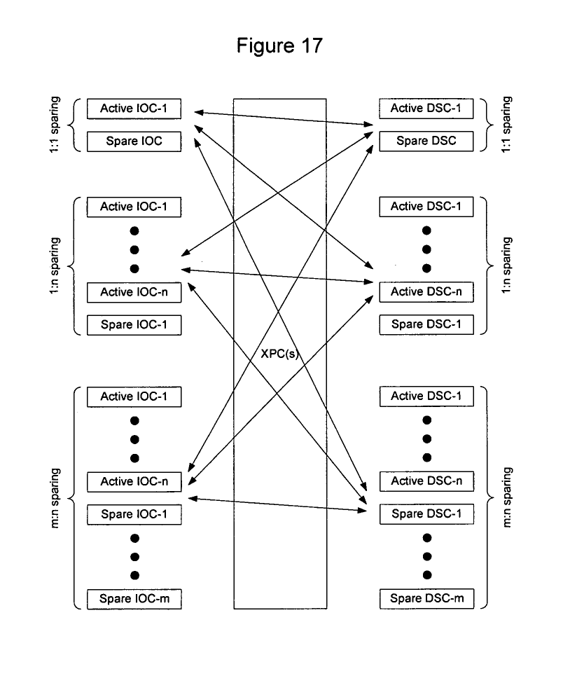

For example, FIG. 17 illustrates several various combinations of sparing that may be implemented in a network element. As shown in FIG. 17, sparing of IOCs is independent of the manner in which DSCs are spared, so that multiple combinations of sparing scenarios may occur. Specifically, as shown in FIG. 17, 1:1, 1:n, and m:n sparing may occur at the IOC side, while using 1:1 sparing on the DSC side. Similarly, 1:1, 1:n, and m:n sparing may occur at the IOC side, while using 1:n sparing on the DSC side or while using m:n sparing on the DSC side. Sparing of the IOCs and DSCs is thus not interrelated as any desired sparing implementation may occur. Sparing of the IOCs and DSCs is also independent of any desired sparing of the XPCs as discussed in greater detail above.

The control plane programs may be implemented in computer software and hosted by one or more the CPUs on the network element. Alternatively, the control plane may be implemented external to the network element and control information may be communicated to the data plane via a communication system such as a network management system connected to a dedicated management port.

The functions described above may be implemented as a set of program instructions that are stored in a computer readable memory within the network element and executed on one or more processors within the network element. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that all functional statements made herein describing the functions to be performed by the methods of the invention may be performed by software programs implemented utilizing subroutines and other programming techniques known to those of ordinary skill in the art. Alternatively, these functions may be implemented in hardware, firmware, or a combination of hardware, software, and firmware. The invention is thus not limited to a particular implementation.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

1. A network element, comprising:
a plurality of Input/Output Cards (IOCs);
a plurality of Datapath Service Cards (DSCs); and
at least a first crosspoint switch card (XPC) configured to be able to selectively interconnect each of said IOCs with each of said DSCs.

2. The network element of claim 1, further comprising a switch fabric configured to dynamically interconnect outputs of said DSCs.

3. The network element of claim 1, further comprising a second XPC configured to selectively interconnect each of said IOCs with each of said DSCs, said second XPC forming a spare XPC for said first XPC.

4. The network element of claim 1, wherein a first subset of the IOCs are working IOCs, a second subset of the IOCs are spare IOCs.

5. The network element of claim 4, wherein the spare IOCs are configured to spare the working IOCs in an m:n fashion.

6. The network element of claim 1, wherein a first subset of the DSCs are working DSCs, and a second subset of the DSCs are spare DSCs.

7. The network element of claim 6, wherein the spare DSCs are configured to spare the working DSCs in an m:n fashion.

8. The network element of claim 1, wherein the XPC is further configured to be able to selectively interconnect IOCs with other IOCs

9. The network element of claim 1, wherein the XPC is further configured to be able to selectively interconnect DSCs with other DSCs.

10. The network element of claim 1, wherein the network element is a SONET switch, and wherein Automatic Protection Switching (APS) is performed at the DSC.

11. The network element of claim 10, wherein a first fiber used on a SONET ring is homed at a first IOC, wherein a second fiber used on the SONET ring is homed at a second IOC, and wherein the DSC enables APS to be performed between the first and second IOCs.

12. The network element of claim 1, further comprising a second XPC, said first XPC having a first set of inputs and a first set of outputs, and said second XPC having a second set of inputs and a second set of outputs, and wherein a plurality of said first outputs are connected to a plurality of said second inputs and wherein a plurality of said second outputs are connected to a plurality of said first inputs.

13. A network architecture for a network element, comprising:
a control plane; and
a data plane, said data plane having a plurality of functional cards and a crosspoint switching structure having an ability to selectively interconnect any of said functional cards with any other of said functional cards.

14. The network architecture of claim 13, wherein the crosspoint switching structure comprises redundant crosspoint switches.

15. The network architecture of claim 13, wherein the data plane comprises a midplane having a plurality of traces extending between the functional cards and the crosspoint switching structure, but does not have direct traces providing direct mesh interconnectivity between the functional cards.

16. A method of implementing Automatic Protection Switching in a network element having Input/Output Cards (IOCs) and Data Service Cards (DSCs) connected in a any-to-any fashion, the method comprising the steps of:
receiving streams of SONET traffic at a plurality of independent and non-interconnected IOCs; and
selecting one of the streams of traffic for processing at a DSC affiliated with said plurality of IOCs.
